(19) United States
(12) Patent Application Publication
(10) Pub. No.: US 2003/0080209 A1
(43) Pub. Date: May 1, 2003

(54) Sprayer container comprising a fabric treatment composition

(75) Inventors: Marion Michele Marie-Pierre Dubreuil, Bruxelles (BE); Graham John Boyd, Strombeek-Bever (BE); Raf Gustaaf Alfons de Geyter, Halen (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/032,947

(22) Filed: Nov. 1, 2001

(51) Int. Cl. B05B 9/043

(52) U.S. Cl. 239/333

(57) ABSTRACT

The present invention is primarily directed to a sprayer container comprising a fabric treatment composition, and/or usage instructions to spray its content onto a fabric on a substantially horizontal surface and iron said fabric, said sprayer container comprising a body comprising a base, a handle and a sprayer head, characterized in that the angle between the symmetry axis of the spray jet and the horizontal axis is 10° to 90°, preferably 30° to 40°, more preferably 35° when said container stands on its base on said surface, and the back portion of said sprayer handle comprises an arc portion. The present invention is further directed to a process of treating fabrics using such a sprayer bottle, which comprises the steps of spraying a liquid composition from a sprayer container onto a fabric, and ironing said fabric on a substantially horizontal ironing surface.

### TECHNICAL FIELD

The present invention relates to a sprayer container comprising a fabric treatment composition, and to a process of treating fabrics using such a sprayer container. The present invention also seeks to provide a sprayer container comprising usage instructions for treatment of fabrics.

### BACKGROUND OF THE INVENTION

Containers for spraying a composition onto fabrics to enhance the ironing process are the most representative of containers for fabric treatment products to which the present invention can apply. Traditionally, compositions for treatment of fabrics to be sprayed onto the surface of garments are stored and dispensed from spray dispensers. Such dispensers typically comprise a container comprising a body, a handle, a neck—that can be the same part as the handle—, and a trigger sprayer head attached to the neck of the container by means of ratchets or screw threads.

Typically, the treatment of fabrics is done on a flat horizontal surface, for example an ironing board. In this situation, two different types of uses of the sprayer bottle are known. Firstly, the user can leave the bottle onto the board and spray the composition onto the fabrics. In such a configuration, the main disadvantage is that the bottle is standing upright, and thus the direction of the spray jet is parallel to the surface of the fabric garments to be treated. Hence an uneven and inefficient coverage of treatment composition onto the surface of the fabrics is observed. Secondly, the user can hold and incline the bottle all along the treatment process, to ensure that the positioning of the spray jet is correct relatively to the surface of the fabrics—i.e. substantially normal to the plane formed by the surface of the fabrics—. In this case, the main disadvantage is that the treatment process proves to be very tiring for the user, which can lead to cramps after triggering several times while holding the bottle in the same position. This can even lead to damages to the wrist in case the treatment of fabrics is done several times a week.

From the above, it is clear that the art does not provide a satisfactory configuration of containers for the treatment of fabrics. Thus there is a need for sprayer container comprising a fabric treatment composition, which is ergonomic to use, and provides optimal treatment of fabrics.

The present invention does not only seek to cover aspects of such a sprayer container itself, but also aspects of the process of treating fabrics using such a sprayer container, and also seeks to cover aspects of such a sprayer container comprising usage instructions to facilitate handling and use by the user.

### SUMMARY OF THE INVENTION

The present invention is primarily directed to a sprayer container comprising a fabric treatment composition, and/or usage instructions to spray its content onto a fabric on a substantially horizontal surface and iron said fabric, said sprayer container comprising a body comprising a base, a handle and a sprayer head, characterized in that the angle between the symmetry axis of the spray jet and the horizontal axis is 10° to 90°, preferably 30° to 40°, more preferably 35° when said container stands on its base on said surface, and the back portion of said sprayer handle comprises an arc portion. The present invention is further directed to a process of treating fabrics using such a sprayer bottle, which comprises the steps of spraying a liquid composition from a sprayer container onto a fabric, and ironing said fabric on a substantially horizontal ironing surface.

### BRIEF DESCRIPTION OF THE DRAWINGS

The present invention will now be explained in detail with reference to the accompanying drawings, in which:

FIG. 1 is a side view of a sprayer bottle according to the present invention.

### DETAILED DESCRIPTION OF THE INVENTION

The present invention is primarily directed to a sprayer container comprising a fabric treatment composition, for use in a ironing process. The present invention also seeks to cover the process of treating fabric garments with a composition and ironing them on a horizontal flat surface.

The Sprayer Container

The sprayer container (1) of the present invention comprises a container body (10), a container neck, and a container handle (11). Preferably, handle (11) and neck are the same element, but alternatively, the handle (11) can be an additional part protruding from the container neck or body. The overall shape of the container (1) should be such that the center of gravity of said container is as low as possible, in order to increase its stability. Preferably the ratio between the volume of the container body (10), and the volume of the rest of the container (neck and handle) should be as high as possible, so as to increase the stability of the container (1) by lowering the center of gravity of said container.

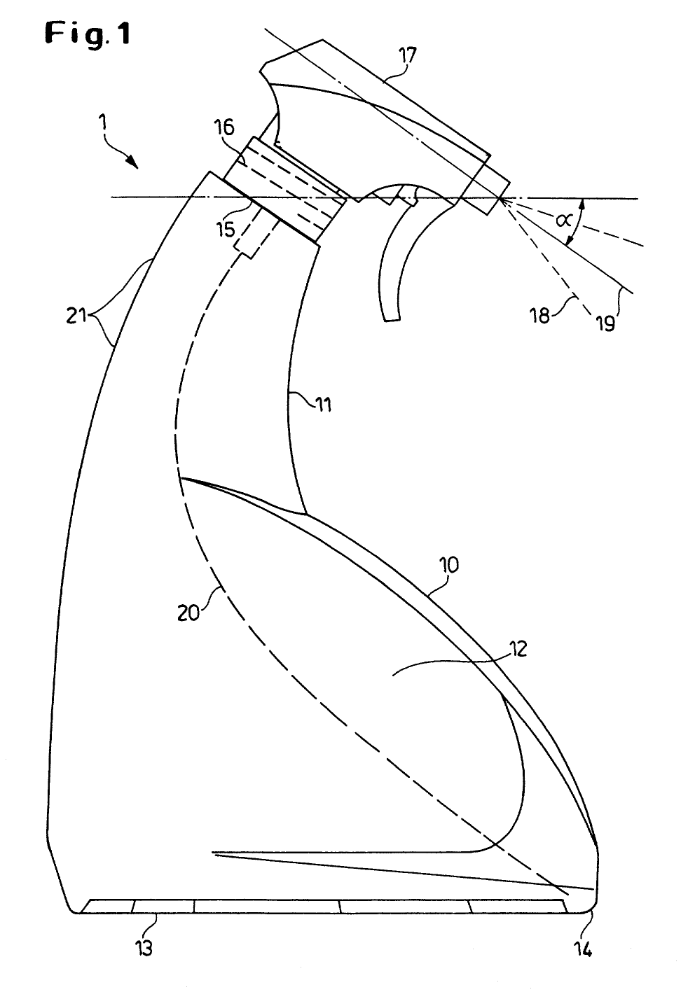

The container body (10) comprises body sidewalls (12), a body bottom (13) forming a base that is substantially flat. The body sidewalls (12) can have any suitable shape and are preferably integrally molded with the neck of the container. As shown in FIG. 1, the bottom front angle (14) of the container body (10) preferably comprises an acute angle, thus defining a sharp front edge (14) of the container body (10). This portion defines a small space with only a limited internal volume.

The neck of the container is preferably elongated to be used as a handle (11), and it more preferably comprises gripping means to facilitate handling by the user, for example a series of ribs in the front portion of said neck. The top portion of the neck comprises at least one dispensing opening (15). Close to the dispensing opening (15), the top portion of the container's neck further comprises means to attach a trigger sprayer head (17), as shown in FIG. 1. The means can be achieved by a series of ratchets that cooperate with corresponding ratchets of the sprayer head (17). In another embodiment, the attachment means (16) can be achieved by screw threads (16) that cooperate with corresponding screw threads (16) of the sprayer head (17).

The container (including body, neck, handle (11)) can be made out of any suitable material, such as glass, a thermoplastic, metal, alloy, cardboard, or a mixture or laminate thereof. Preferably, it is made out of plastic. Said container can be made by using any suitable manufacturing process, such as injection molding, extrusion blow molding, injection blow molding, etc. . . .

The sprayer container (1) of the present invention, further comprises a trigger sprayer head (17) that is attached to the container and normally closes the dispensing opening (15) of said container. Trigger sprayer heads are well known in the art, and the skilled person will be able to appropriately choose a suitable trigger sprayer head (17), depending on what kind of dispensing is wanted. The spray jet (18) can be of any suitable shape, for example conic, flat fan-like, linear, etc. . . . Whatever its shape, the spray jet (18) comprises a symmetry axis (19), which is taken as a basis to define the general direction of said spray jet (18). The size of the droplets will also depend on the type of spray nozzle, and will be appropriately chosen by the person skilled in the art, depending on what coverage is to be achieved. By trigger sprayer head (17), it is meant any mechanical means that pumps product into the container and releases said product under the form of a spray or mist onto the target (in the context of the present invention, the target is a surface of fabric garments). The trigger sprayer head (17) can be a purely manually activated and operated means, or it can be achieved by an electrical sprayer. By electrical sprayer, it is meant a non-manually activated sprayer—which can be an electrical pump, an ultrasonic nebulizer, or any other type of electrical means of producing a fine mist of particles, which are deposited onto the surface of the fabric garments—. The trigger sprayer head (17) further comprises a dip tube (20) that plunges into the container body (10). The dip tube (20) is preferably bent, and its bottom extremity—i.e. the extremity that is directed into the container body (10)—is most preferably located into the sharp front edge (14) of the container body (10), as shown in FIG. 1. Also preferably, the bottom extremity of the dip tube (20) comprises a notch, so as to prevent clogging of its opening when said dip tube (20) is in contact with the bottom of the container body (10).

It is an essential feature of the sprayer container (1) according to the present invention that it be made such that the angle a between the symmetry axis (19) of the spray jet (18) and the horizontal axis is 10° to 90°, preferably 30° to 40°, more preferably 35° when said container stands on its base on said surface, as shown in FIG. 1. It has been found that such an angle—especially an angle of 35°—provides a better dispensing and even coverage of the surface of fabric garments, when the sprayer container (1) and said garments are standing on a flat horizontal surface, for example an ironing board. The direction of the symmetry axis (19) of the spray jet (18) can be achieved in different ways. In a first—and preferred—embodiment of this invention, the sprayer comprises a curved neck, which is bent towards the front of said sprayer, as shown in FIG. 1. In such an embodiment, the curvature is such that the final angle of the symmetry axis (19) of the spray jet (18) is as defined above. In addition, at least the back portion of the neck then comprises an arc, as defined below, that makes the container particularly ergonomic to handle, thus decreasing the tiredness if the user when grabbing said container. In a second embodiment of this invention, the sprayer container (1) comprises a straight neck with a angled finish, such that once attached thereon, the trigger sprayer head (17) is angled relatively to the rest of the container. In a third embodiment, the trigger spray head (17) is constructed such that the spray nozzle points downwards when the container is standing on a horizontal surface. In a fourth embodiment, the spray container comprises an angled base, such that, when standing on its base, the whole container is inclined towards the flat surface where it is standing (like the Pisa tower).

It is another essential feature of a sprayer container (1) according to the present invention that the back portion of said sprayer handle comprises an arc portion (21). In a preferred embodiment of the present invention, said curved back portion (21) has a length of at least 3 cm, more preferably at least 7 cm. Also preferably, the convexity of the arc protrudes towards the back of the sprayer container (1) handle, so as to conform to the palm of the user during handling. It has been surprisingly found that such a shape, independent of the rest of the handle, is particularly ergonomic and facilitates handling and use of the container, while decreasing the effort requires spraying a given quantity of product.

In addition, it is highly beneficial to the present invention that the sprayer container (1) comprises a set of usage instructions. Such usage instructions describe the different steps to follow in order to use said sprayer container in a process of ironing as described hereafter. The usage instructions can take the form, for example of a set of pictures or ideograms that are printed onto a label, and said label is stuck to the body walls (12) of the container (1).

Stability of the Container

It is a preferred embodiment of the container of the present invention that the sprayer container (1) of the present invention be constructed such that the ratio between the total height of the sprayer container (1) (including container body (10) and sprayer head (17)) and the height of 125 ml of product inside the container body (10) is more than 6.5. It has been found that such a configuration of a sprayer container (1) is particularly stable. Stability of the container is a particularly critical when to be used in the context of ironing. For example, while the container is staying on the ironing board, the user must be able to handle and displace garments around the container, and in case the garments catch the sprayer container (1), it must be as stable as possible so that it will not fall. It has been found that a shape for the container, as shown for example in FIG. 1 provides good stability, as the center of gravity of the whole sprayer container (1) is low. Such a good stability is particularly beneficial in combination with the above-mentioned features of the container, especially the angled spray direction, and the ergonomic handle, and makes the whole container very ergonomic and safe to use while handling a hot iron.

The Process

The present invention further seeks to provide a process of treating a fabric. The process comprises the steps of spraying a liquid composition from a sprayer container as described above onto a fabric, and ironing said fabric on a substantially horizontal ironing.

The Compositions

The following fabric treatment compositions suitable for use in the context of the present invention are merely given as examples, and are not intended to limit the scope of the present invention. Such compositions typically comprise fabric treatment compositions, for example fabric de-wrinkling and/or easy-ironing compositions. Details of such compositions are given for example in PCT application number WO 99/55951 to The Procter & Gamble Company, published Apr. 11, 1999. It discloses a wrinkle reducing composition, comprising:

A—a wrinkle reducing active, comprising an adhesive polymer having a weight average molecular weight from 5000 to 1,000,000, which has an organic polymeric backbone, said copolymer comprising monomers selected from the group consisting of A monomers, B monomers and mixtures thereof, wherein said copolymer is prepared by the polymerization combination of the following relative weight percentages of said A monomers, and said B monomers:

a—from about 0% to about 100%, by weight of said copolymer, of a hydrophobic, A monomer, free radically copolymerizable with said B monomers;

b. from 0% to about 100%, by weight of said copolymer, of a hydrophilic reinforcing B monomer, copolymerizable with said A monomer, said B monomer being selected from the group consisting of polar monomers and macromers and mixtures thereof; and

B—an uncomplexed cyclodextrin.

Another example of fabric treatment compositions suitable for use in the context of the present invention is given in WO 00/08249 to The Procter & Gamble Company, published Feb. 17, 2000. It discloses a wrinkle reducing composition, comprising:

A—a wrinkle reducing active, comprising an adhesive polymer selected from:

I—a silicone grafted adhesive copolymer having a molecular weight of from 10,000 to 1,000,000, which has an organic polymeric backbone having grafted to it monovalent siloxane polymeric moieties, said copolymer comprising C monomers and components selected from the group consisting of A monomers, B monomers, and mixtures thereof; wherein:

a. A is at least one free radically polymerizable organic monomer, the amount by weight of A monomer, when used, being up to about 100% of the total weight of all monomers in said backbone;

b. B is at least one reinforcing monomer copolymerizable with A, the amount by weight of B monomer, when used, being up to about 100% of the total weight of all monomers in said backbone, said B monomer being selected from the group consisting of polar monomers and macromers; and

c. C is a polymeric monomer copolymerizable with said A monomer and said B monomer, said C monomer having a having a molecular weight of from about 1,000 to about 50,000; and having the general formula:

X(Y)ₙSi(R)₃₋ₘ(Z)ₘ

wherein:

X is a vinyl group copolymerizable with said A monomers and said B monomers;

Y is a divalent linking group;

R is a hydrogen, lower alkyl, aryl or alkoxy;

Z is a monovalent siloxane polymeric moiety having a number average molecular weight of at least about 500, is essentially unreactive under co polymerization conditions, and is pendant from said polymeric backbone after co polymerization;

n is 0 or 1;

m is an integer from 1 to 3; and

wherein C comprises from about 0.01% to about 50% of the copolymer;

II—a polymer having a weight average molecular weight from 5000 to 1,000,000, which has an organic polymeric backbone, said copolymer comprising monomers selected from the group consisting of A monomers, B monomers and mixtures thereof, wherein said copolymer is prepared by the polymerization combination of the following relative weight percentages of said A monomers, and said B monomers:

a—from 0% to about 100%, by weight of said copolymer, of a hydrophobic, A monomer, free radically copolymerizable with said B monomers;

b. from 0% to about 100%, by weight of said copolymer, of a hydrophilic reinforcing B monomer, copolymerizable with said A monomer, said B monomer being selected from the group consisting of polar monomers and macromers and mixtures thereof; and

III—an adhesive block copolymer having a weight average molecular weight from about 10,000 grams/mole to about 10,000,000 grams/mole and which is formed from the free radical polymerization of an ethylenically unsaturated monomer with a silicone macro initiator selected from the group consisting of:

[[SiR₂O]ₘ—SiR₂—XYX]ₙ,

—XYX—[[SiR₂O]ₘ—SiR₂—XYX]]ₙ—,

—[[SiR₂O]ₘ—SiR₂—XYX]ₙ—[SiR₂O]ₚ—,

and combinations thereof, wherein each R is independently selected from the group consisting of C1-C10 alkyl, phenyl, C1-C10 alkyl-substituted phenyl, and mixtures thereof, X is a divalent radical, Y is selected from the group consisting of

—N═N—

—O—O—

and combinations thereof; and m, n, and p are positive integers independently having a value of 1 or greater; and

wherein the silicone macro initiator has a number average molecular weight from about 500 grams/mole to about 500,000 grams/mole, and the ethylenically unsaturated monomers are copolymerizable and form one or more polymeric blocks within the adhesive block copolymer having a Tg value of from about −20° C. to about 60° C.

IV—mixtures thereof;

B—a water-solubilising agent;

C—a liquid aqueous carrier, and

wherein when the polymer is as defined under (I) or (II) said water-solubilising agent is in amount of less than 5% by weight of the composition and is selected from water-soluble anionic surfactant, water-soluble nonionic surfactant, and mixtures thereof.

What is claimed is:

1. A process of treating a fabric which comprises the steps of spraying a liquid composition from a sprayer container onto a fabric, and ironing said fabric on a substantially horizontal ironing surface, said sprayer container comprising a body with a base, a handle having a back portion, a sprayer head, and a spray jet, said spray jet having a symmetry axis, wherein the angle between the symmetry axis of the spray jet and the horizontal axis is about 10° to about 90° when said container stands on its base on said surface, and the back portion of said sprayer handle comprises an arc portion.

2. A process of treating a fabric according to claim 1 wherein the angle between the symmetry axis of the spray jet and the horizontal axis is about 30° to about 40° when said container stands on its base on said surface, and the back portion of said sprayer handle comprises an arc portion.

3. A process of treating a fabric according to claim 1 wherein the angle between the symmetry axis of the spray jet and the horizontal axis is about 35° when said container stands on its base on said surface, and the back portion of said sprayer handle comprises an arc portion.

4. A process according to claim 1 wherein said handle and said sprayer head are inclined towards said ironing surface when said container stands on its base on said surface.

5. A sprayer container comprising usage instructions to spray its content onto a fabric on a substantially horizontal surface and iron said fabric, said sprayer container comprising a body comprising a base, a handle having a back portion, a sprayer head, and a spray jet, wherein the angle between the symmetry axis of the spray jet and the horizontal axis is about 10° to about 90° when said container stands on its base on said surface, and the back portion of said sprayer handle comprises an arc portion.

6. A sprayer container according to claim 5 wherein the angle between the symmetry axis of the spray jet and the horizontal is about 30° to about 40° when said container stands on its base on said surface, and the back portion of said sprayer handle comprises an arc portion.

7. A sprayer container according to claim 5 wherein the angle between the symmetry axis of the spray jet and the horizontal is about 35° when said container stands on its base on said surface, and the back portion of said sprayer handle comprises an arc portion.

8. A sprayer container according to claim 5 wherein said handle and said sprayer head are inclined towards said ironing surface when said container stands on its base on said surface.

9. A sprayer container comprising a fabric treatment composition, said sprayer container comprising a body comprising a base, a handle having a back portion, a sprayer head, a spray jet, wherein the angle between the symmetry axis of the spray jet and the horizontal axis is about 10° to about 90° when said container stands on its base on said surface, and the back portion of said sprayer handle comprises an arc portion.

10. A sprayer container according to claim 9 wherein the angle between the symmetry axis of the spray jet and the horizontal axis is about 30° to about 40° when said container stands on its base on said surface, and the back portion of said sprayer handle comprises an arc portion.

11. A sprayer container according to claim 9 wherein the angle between the symmetry axis of the spray jet and the horizontal axis is about 35° when said container stands on its base on said surface, and the back portion of said sprayer handle comprises an arc portion.

12. A sprayer container according to claim 9 wherein said handle and said sprayer head are inclined towards said ironing surface when said container stands on its base on said surface.
